(19) United States
(12) Patent Application Publication
(10) Pub. No.: US 2021/0057977 A1
(43) Pub. Date: Feb. 25, 2021

(54) A LOW COST MAGNETICALLY GEARED LEAD SCREW (MGLS)

(71) Applicant: Portland State University, Portland, OR (US)

(72) Inventors: Jonathan Bird, Portland, OR (US); Mojtaba Bahrami Kouhshahi, Portland, OR (US)

(73) Assignee: Portland State University, Portland, OR (US)

(21) Appl. No.: 16/607,067

(22) PCT Filed: Apr. 23, 2018
(86) PCT No.: PCT/US2018/028958

§ 371 Date: Oct. 21, 2019

Related U.S. Application Data
(63) Continuation-in-part of application No. 15/272,722, filed on Sep. 22, 2016, now abandoned.
(60) Provisional application No. 62/488,739, filed on Apr. 22, 2017.
(60) Provisional application No. 62/195,951, filed on Jul. 23, 2015.
(60) Provisional application No. 62/195,951, filed on Jul. 23, 2015.

(51) Int. Cl. H02K 49/10; H02K 7/06; H02K 51/00; F16H 25/24

(52) U.S. Cl. CPC H02K 49/102; H02K 7/06; F16H 2025/249; F16H 25/24; H02K 51/00

(57) ABSTRACT

This application concerns embodiments of a low cost magnetically geared lead screw (MGLS). In some embodiments, a MGLS system comprises at least an outer cylinder, an inner rotor, and a translator sandwiched between the outer cylinder and the inner rotor. In various embodiments, the MGLS overcomes some of the disadvantages of other systems by skewing magnetic pole pairs on either or both of the outer cylinder or the inner rotor instead of skewing magnetic portions of the translator. By skewing the pole pairs, the translator placed between the outer and inner cylinder is generally not required to contain any magnetic material (such as permanent magnets or magnetic rings, rare earth elements, etc.), which may otherwise cause the translator to become costly and/or heavy, or to exhibit any other number of deficiencies.

### CROSS REFERENCE TO RELATED APPLICATIONS

This application claims the benefit of U.S. Provisional Application No. 62/488,739 filed on Apr. 22, 2017, entitled “A LOW COST MAGNETICALLY GEARED LEAD SCREW”, which is incorporated herein by reference in its entirety.

This application is also a continuation-in-part of U.S. Nonprovisional application Ser. No. 15/272,722 filed on Sep. 22, 2016, and entitled “MAGNETICALLY GEARED LEAD SCREW” and U.S. Provisional Application No. 62/195,951, filed on Jul. 23, 2015, entitled “MAGNETICALLY GEARED LEAD SCREW”, which are both incorporated herein by reference in their entirety.

### ACKNOWLEDGMENT OF GOVERNMENT SUPPORT

This invention was made with government support under Contract No. 1636704 awarded by The National Science Foundation (NSF). The government has certain rights in the invention.

### FIELD

The field of this application pertains generally to low cost magnetically coupled actuator devices and low cost systems of magnetically coupled actuator components.

### BACKGROUND

For many applications, it is desirable to convert linear energy to rotational energy (or vice versa), to convert linear energy into stepped-up or stepped-down linear energy, or to convert rotational energy into stepped-up or stepped-down rotational energy. The desired result is often addressed by using mechanical or electromechanical actuators. In an actuator, a control signal and a source of energy are usually required to perform the translation of energy from one form into another. The control signal may be of relatively low energy and may be an electric voltage or current, pneumatic or hydraulic pressure, or even human power. The supplied main energy source may be an electric current, a hydraulic fluid pressure, or a pneumatic pressure. When the control signal is received, the actuator typically responds by converting the supplied energy into some form of mechanical motion, or by converting the mechanical motion into some form of stored or translational energy.

However, mechanical and electromechanical actuators can suffer from numerous problems. For example, a mechanical actuator may rely on hydraulics. Hydraulic actuators usually consist of a cylinder or a fluid motor that uses hydraulic power to facilitate mechanical operation. The mechanical motion can then give an output in terms of linear, rotatory or oscillatory motion. Since most liquids are nearly impossible to compress, a hydraulic actuator can exert a large force. A drawback of this approach, however, is limited mechanical acceleration of a component (say, a piston) during the energy translation process. Additionally, hydraulic actuators can leak, which can create environmental hazards. Hydraulic actuators may also require regular maintenance. This can be especially problematic for marine hydrokinetic generators that operate offshore, and are thus particularly problematic to service.

Other types of mechanical actuators can include pneumatic actuators, purely mechanical (non-fluid and/or non-gaseous) actuators, and more. A pneumatic actuator, for example, can convert energy formed by vacuum or compressed air at high pressure into either linear or rotary motion. Alternatively, a purely mechanical actuator can take the form of, for example, a rack and pinion mechanism that may require gears, rails, pulleys, chains, or other physical systems to operate. Due to the necessary physical contact of components within each of these devices, some amount of wear and/or maintenance (such as lubrication or part replacement) is usually expected. Hydraulic, as well as pneumatic systems, can also require additional pumps and tubing, which makes their installation complex, expensive, and can result in bulky and/or inefficient systems. Hydraulic and pneumatic actuators also typically operate efficiently only within a narrow operating region.

Electromechanical actuators function in a similar manner Electromechanical actuators are typically composed of a mechanical lead screw driven by an electrical motor Due to the mechanical contact between parts, however, electromechanical actuators can still suffer from some of the above-mentioned problems. Additionally, electromechanical actuators can suffer from issues such as noise and reliability, causing their operational design life to be limited, particularly if regular servicing is not undertaken. Consequently, it is desirable to construct an actuator that does not suffer from one or more of the above mentioned effects. Furthermore, it is desirable for such an actuator to be inexpensive to produce.

### SUMMARY

In this application, example embodiments of a low-cost magnetically geared lead screw (MGLS) are introduced. Unlike mechanical or electromechanical actuation systems, electromagnetic (or henceforth, magnetic) systems such as linear magnetic gears (LMG's) and magnetic lead screws (MLS's) work on principles of non-contact force carrying electromagnetic fields to translate permutations of linear and/or rotational energy into one another. Example embodiments of the disclosed technology allow for energy to be transferred between separate bodies without physical contact. Some example advantages that can be realized by this approach include the substantially frictionless translation of energy, and also rapid recovery in the event of torque overload slippage.

In some embodiments, a MGLS system comprises at least an outer cylinder, an inner rotor, and a translator sandwiched between the outer cylinder and the inner rotor. In various embodiments, the MGLS can be capable of overcoming some of the disadvantages of prior art systems by skewing magnetic pole pairs on either or both of the outer cylinder or the inner rotor instead of skewing magnetic portions of the translator. By skewing the pole pairs, the translator placed between the outer and inner cylinder is generally not required to contain any magnetic material (such as permanent magnets or magnetic rings, rare earth elements, etc.), which may otherwise cause the translator to become costly and/or heavy, or to exhibit any other number of deficiencies. Accordingly, the translator can comprise relatively inexpensive ferromagnetic metals (such as ferromagnetic steel) instead of permanent magnetic or electromagnetic (current carrying) materials, and can thus operate at a higher force-per-kilogram magnet material.

This may be particularly useful in instances where the translator extends axially beyond the outer cylinder and/or inner rotor. One area of application that could benefit from such an arrangement is in clean energy marine applications that attempt to harness energy from kinetic waves such as those occurring in oceans, lakes, rivers, etc. Of course, any other form of kinetic physical energy fluctuations may also be utilized to store or provide energy such as air currents (turbines), seismic waves, geothermal fluctuations, etc. It is also possible to employ MGLS systems in various consumer or military applications such as in vehicles or industrial machines, etc.

As an example, in clean energy marine applications, renewable energy from waves can be utilized to actuate the translator in a linear (say, up-and-down or back-and-forth) motion relative to the inner rotor and outer cylinder. This linear motion can subsequently be converted into various forms of energy resources, such as rotational energy, stepped linear energy, stored energy, etc. This energy transfer occurs due to the interaction of electromagnetic fields between the translator and the other actuator components. However, since ocean waves can vary considerably in size and force depending on weather conditions, time of year, etc., a long translator composed (at least partially) of magnetic materials along its length would be inefficient, since calm days would leave much of the translator magnetic materials inactive (short translator strokes) relative to the inner rotor and outer cylinder. But, even on days in which the entire length of the translator is being used (long translator strokes), it would still be cheaper to not outfit the (relatively long) translator with magnetic material if another solution is possible. By skewing magnetic poles of one or both of the outer cylinder and inner rotor, rather than outfitting the translator with magnetic materials, such a solution can be made to be possible.

The foregoing and other objects, features, and advantages of the invention will become more apparent from the following detailed description, which proceeds with reference to the accompanying figures.

### BRIEF DESCRIPTION OF THE DRAWINGS

FIG. 1 depicts a linear magnetic gear (LMG);

FIG. 2 depicts a magnetic lead screw (MLS);

FIG. 3 depicts a magnetically geared lead screw (MGLS);

FIG. 4 depicts an MGLS with a skewed translator;

FIG. 5 depicts an example MGLS with skewed outer cylinder poles;

FIG. 6 depicts maximum translator force versus axial shift, Lₐ of half rings in an MGLS;

FIG. 7 depicts an example low-cost MGLS in accordance with an embodiment of the disclosure;

FIG. 8 depicts the radial flux density in the outer airgap of an example MGLS along the MGLS axial length when permanent magnets (PMs) are only present on the inner rotor;

FIG. 9 depicts the harmonic contents of the radial flux density in the outer airgap of the MGLS of FIG. 8 when PMs are only present on the inner rotor;

FIG. 10 depicts the radial flux density in the inner airgap of an example MGLS along the axial length of the MGLS when PMs are only present on the outer cylinder;

FIG. 11 depicts the harmonic contents of the radial flux density in the inner airgap of an example MGLS when PMs are only present on the outer cylinder;

FIGS. 12a and 12b depict (a) force and (b) torque on example MGLS part as a function of inner rotor angular spatial position;

FIG. 13 depicts torque on different parts of a MGLS due to rotation of the inner rotor and translation of the translator at the same time;

FIG. 14 depicts force on different parts of a MGLS due to rotation of the inner rotor and translation of the translator at the same time;

FIG. 15 depicts translator force of a disclosed low cost MGLS compared with a MGLS with skewed translator rings;

FIG. 16 depicts cross sectional dimensional parameters for a disclosed MGLS;

FIG. 17 depicts trade-off between maximizing volumetric force density and force-per-kg of magnet material for an iteration IV;

FIG. 18 depicts translation force as a function of translator outer radius rₜₒ and inner rotor outer radius rᵢₒ for an iteration V;

FIG. 19 depicts a side view of a MGLS segmented helical inner rotor, and one helix turn;

FIG. 20 depicts radial flux densities in the outer air-gap of a MGLS due to magnets only on the inner rotor;

FIG. 21 depicts harmonic values of radial flux densities in the outer air-gap of a MGLS due to magnets only on the inner rotor (e.g., translator modulation);

FIG. 22 depicts force on different parts of an example MGLS due to rotation of the inner rotor;

FIG. 23 depicts torque on different parts of an example MGLS due to rotation of the inner rotor;

FIG. 24 depicts force on different parts of an example MGLS due to rotation of the inner rotor and translation of the translator at the same time;

FIG. 25 depicts torque on different parts of an example MGLS due to rotation of the inner rotor and translation of the translator at the same time;

FIG. 26 depicts an example MGLS test setup;

FIG. 27 depicts measured and calculated MGLS translator force for an example MGLS with and without 0.1 mm space between rings;

FIG. 28 depicts a close up view (not to scale) of the translator pole-pieces and w₉=0.1 mm space between plastic (black) and steel rings (gray) for an example MGLS;

FIG. 29 depicts the variation of the translator force due to introduction of a small space between two adjacent translator rings;

FIG. 30 shows an example of a linear magnetic actuator with pᵢ=15 inner pole-pairs, pₒ=6 outer pole pairs and nₜ=21 central ferromagnetic rings;

FIG. 31 provides one example of a magnetic lead screw in accordance with embodiments presented herein;

FIG. 32A shows a structure of proposed magnetically geared linear screw in accordance with embodiments presented herein;

FIG. 32B shows some examples of the cross-sectional dimensional values or the screw of FIG. 32A;

FIG. 33A shows radial flux densities and related spectrums: a) adjacent to inner rotor due to inner rotor magnets at r=17.55 mm);

FIG. 33B shows radial flux densities and related spectrums adjacent to outer rotor due to inner rotor magnets (at r=19.95 mm);

FIG. 34A shows radial flux densities and related spectrums a) adjacent to outer rotor due to outer rotor (at r=19.95 mm);

FIG. 34B shows radial flux densities and related spectrums adjacent to inner rotor due to outer rotor (at r=17.55 mm);

FIG. 35 shows the force along the z-direction on different parts due to rotation of inner rotor;

FIG. 36 shows torque on different parts due to rotation only on the inner rotor;

FIG. 37 shows force in the z-direction on the different parts due to rotation of inner rotor and translation of translator at the same time;

FIG. 38 shows torque on each part due to rotation of the inner rotor and translation of translator at the same time.

### DETAILED DESCRIPTION

### I. General Considerations

Disclosed below are representative embodiments of methods, apparatus, and systems for implementing magnetically geared lead screws. The disclosed methods, apparatus, and systems should not be construed as limiting in any way. Instead, the present disclosure is directed toward all novel and nonobvious features and aspects of the various disclosed embodiments, alone or in various combinations and sub-combinations with one another. Furthermore, any features or aspects of the disclosed embodiments can be used in various combinations and sub-combinations with one another. For example, one or more method acts from one embodiment can be used with one or more method acts from another embodiment and vice versa. The disclosed methods, apparatus, and systems are not limited to any specific aspect or feature or combination thereof, nor do the disclosed embodiments require that any one or more specific advantages be present or problems be solved.

For the sake of simplicity, the attached figures may not show the various ways in which the disclosed methods, apparatus, and systems can be used in conjunction with other methods, apparatus, and systems. Additionally, as used herein, the term “and/or” means any one item or combination of any items in the phrase.

### II. Detailed Description of Example Low-Cost Magnetically Geared Lead Screws (MGLSs)

Hydraulic actuators are commonly used as linear actuators, due to their very high force density and high stiffness. However, hydraulic systems pose a potential leakage hazard, and can cause negative environmental impacts. This is especially true for marine hydrokinetic generators. Hydraulic as well as pneumatic systems require additional pumps and tubing, which makes their installation complex, expensive and overall they can be bulky. Hydraulic and pneumatic actuators also typically only operate efficiently within a narrow operating region. As an alternative, electromechanical actuators, are often considered. Electromechanical actuators typically comprise a mechanical lead screw driven by an electrical motor. Due to the mechanical contact between parts, however, electromechanical actuators still suffer from noise and low reliability, and therefore their operational design life is limited, particularly if regular servicing is not undertaken.

An alternative to mechanical or electromechanical actuators is an electromagnetic linear actuator (ELA), which creates linear motion entirely from the magnetic forces created by a stator and linear translator. An ELA is able to operate at a higher overall efficiency when compared to the hydraulic and electromechanical actuators, and the entirely non-contact force production results in the reliability being higher than alternative hydraulic and electromechanical actuators. However, the force density of an ELA is constrained by the current density and magnetic saturation.

Other types of linear actuator, known as linear magnetic gears (LMGs) and magnetic lead screws (MLSs) rely on magnetic loading and can help overcome the limitations of ELAs. Linear magnetic gears (LMGs) and magnetic lead screws (MLSs) are capable of achieving a significantly higher force density in comparison to the other linear actuators.

An example LMG 100 is illustrated in FIG. 1. The LMG 100 utilizes magnetic field modulation to create linear motion speed change without direct physical contact between the respective components of the inner cylinder 110, the outer cylinder 130, and the translator 120. In the example shown in FIG. 1, the inner cylinder 110 includes pᵢ permanent magnetic pole pairs (as shown by the alternating red/blue coloring or alternating grayscale shading), a (central) translator 120 including nₜ magnetic ferromagnetic pole pieces, and an outer cylinder 130 including p, permanent magnetic pole pairs. The LMG 100 creates speed change when the inner pole-pairs pᵢ and outer pole-pairs pₒ are related to the nₜ central ferromagnetic pole-pieces by:

nₜ=pₒ+pᵢ (1)

The speed relationship between the translating moving parts can then be defined by:

νₜnₜ=νₒpₒ+νᵢpᵢ (2)

where νᵢ, νₒ, and νₜ are the speeds of the inner cylinder 110, the outer cylinder 130, and the translator 120. If νₒ=0 (stationary outer cylinder 130), the speed relationship can then be given by:

$${v}_{i} = {v}_{t} ( \frac{{n}_{t}}{{p}_{i}} ) \qquad ( 3 )$$

where the quantity

$$\frac{{n}_{t}}{{p}_{i}}$$

represents the gear ration. In FIG. 1, pᵢ=15, pₒ=6, and thus nₜ=pₒ+pᵢ=21.

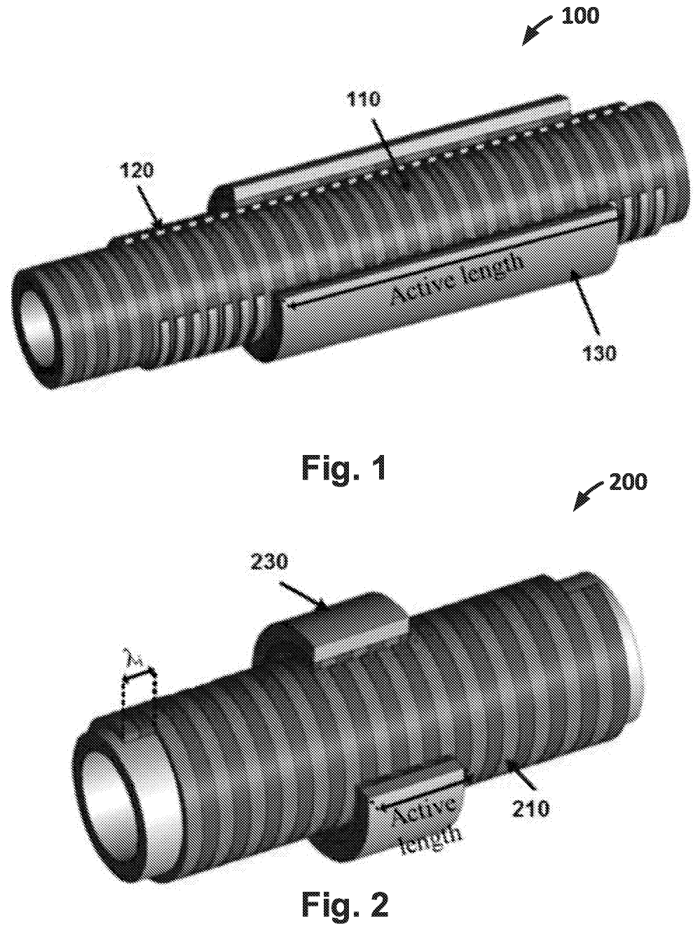

FIG. 2 illustrates another example MLS structure 200. In MLS 200, linear motion can be converted to rotary motion (and vice-versa) via the electromagnetic interaction between helically disposed, radially magnetized permanent magnets on one or more of the MLS components (where alternating pole pairs are shown by the alternating red/blue coloring or grayscale shading). In FIG. 2, this corresponds to the interaction between a helically wound magnetic nut 230 and a helically wound magnetic screw 210. The parameter indicates the inner rotor lead, which is typically twice the magnetic pole pitch. The relationship between these components can be expressed as:

$$\begin{matrix}{v}_{i} = {k}_{i} {ω}_{i} \\ where & ( 4 ) \\ {k}_{i} = \frac{{λ}_{i}}{2 π} & ( 5 )\end{matrix}$$

The MLS 200 is a magnetic counterpart of the mechanical lead screw. Both the magnetic screw 210 and magnetic nut 230 in the MLS structure are made of helically shaped radially magnetized permanent magnets. In the illustrated embodiment, one turn rotation of the inner rotor (magnetic screw 210), makes the outer translator (magnetic nut 230) move by twice the magnet's pole-pitch, which is the definition of the inner rotor lead λᵢ. The relationship between the angular velocity, ωᵢ, and translating speed, νᵢ is related by the rotor lead such that:

$${v}_{i} = ( \frac{{λ}_{i}}{2 π} ) {ω}_{i} \qquad ( 6 )$$

One drawback of the MLS 200 and LMG 100 devices is that the axial length of at least one of the magnetic material containing parts must always be chosen to be equal to the active length of the particular device, plus the stroke length of the device. This is necessary to ensure that the translator 120 can interact effectively with the other device components 110 and 130. This means that in long stroke length applications, a large quantity of permanent magnetic material (say, on the inner cylinder 110) will be used and which does not contribute to the force production at many times during operation as the magnetic material is beyond the physical bounds of the outer cylinder 130. Therefore, in long-stroke-length applications, the LMG and MLS will have a low force-per-kg of magnet material usage.

More specifically, both the LMG 100 and the MLS 200 require that the inner cylinder translator 110, and magnetic screw translator 210 contain a large quantity of magnetic material, such as permanent magnets, rare earth metal magnets, or even current carrying electromagnets (though the latter is generally not preferred due to the required current consumption of such magnets in addition to the increased complexity of the overall system). This can make both the MLS 200 and LMG 100 costly and bulky/heavy.

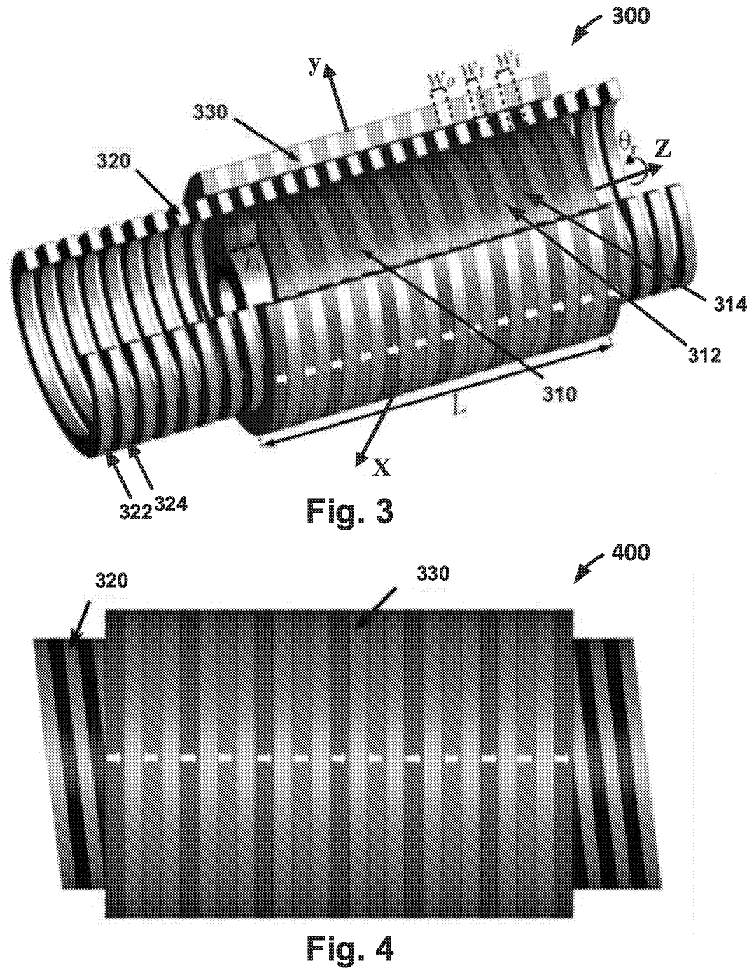

FIG. 3 illustrates an example of a magnetically geared lead screw, MGLS 300 in accordance with an embodiment of the disclosure. Unlike the LMG 100 and the MLS 200, the translator 320 of certain embodiments of the MGLS 300 can be fabricated from rings of partially or purely ferromagnetic metals, such as ferromagnetic steel. This desirable characteristic decreases the magnetic materials for the structure (as shown above), and can significantly lower cost and weight. Further, in the example design of FIG. 3, the force-per-kilogram of magnet materials does not decrease when the axial length of the translator 320 increases.

The example MGLS 300 can convert low speed linear motion to high speed rotary motion and vice-versa. Radially magnetized helically mounted inner rotor permanent magnets (shown as helical permanent magnet 312 and helical permanent magnet 314 mounted on the inner rotor (shown generally at 310), where the magnets 312 and 314 have opposite polarities to one another) can create a traveling magnetic field in the inner airgap of the MGLS300. Through the magnetic field modulation, the ferromagnetic rings (examples of which are shown as ferromagnetic ring 322 and ferromagnetic ring 324) on the translator (shown generally at 320) can then create additional spatial harmonics in the outer airgap. The modulated magnetic field can then interact with the magnetic field of the outer cylinder 330 to create a translation force on the ferromagnetic rings of the translator 320. As with the MLS 200, rotation of the inner rotor 310 with angular velocity ωᵢ may create a translational velocity ν₁. With the outer cylinder 330 stationary, the relationship between linear translator 320 speed νₜ and angular velocity ωᵢ can be calculated. That is, if the MGLS satisfies eq. (1), it can be shown that the translator speed νₜ will be related to the inner rotor rotational speed, ωᵢ, by:

$${ω}_{i} = ( \frac{{n}_{t}}{{p}_{i} {k}_{i}} ) {v}_{t} \qquad ( 7 )$$

where kᵢ is defined as:

$${k}_{i} = \frac{{λ}_{i}}{2 π} \qquad ( 8 )$$

Equation (7) shows that the MGLS 300 can convert translational motion into rotational motion, or rotational motion into translational motion via a gear ratio. As the translator 320 stroke length can be made very long without requiring more magnetic material, the MGLS 300 is able to operate with a higher force-per-kilogram of magnetic material when used, for example, in long-stroke-length applications. In order for the inner rotor 310 and translator 320 fields to couple, and in the illustrated embodiment, the inner rotor 310 magnets are helically skewed and the translator 320 ferromagnetic rings are axially skewed. FIG. 4 more clearly shows the axial skewing of the ferromagnetic translator rings in the example MGLS 300 relative to the outer cylinder 330. The skewing of the translator 320 rings, however, can significantly increase the manufacturing cost of the MGLS 300 as it is difficult to fabricate the skewed rings to a high tolerance. Also, small tolerance inaccuracies in the rings can cause the force to reduce significantly when compared to predicted values.

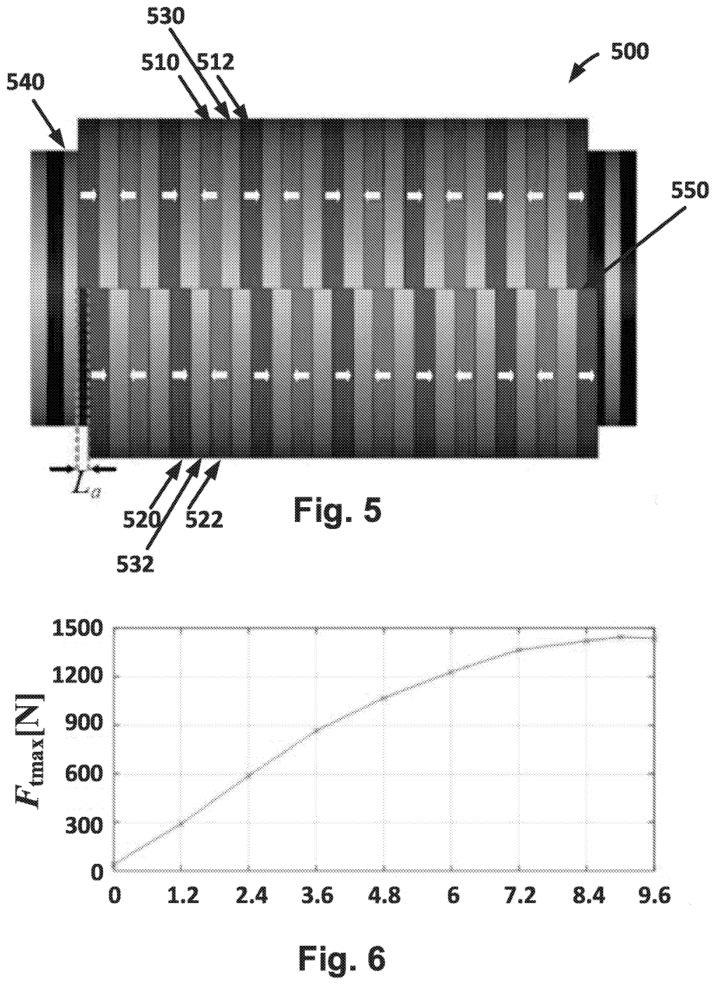

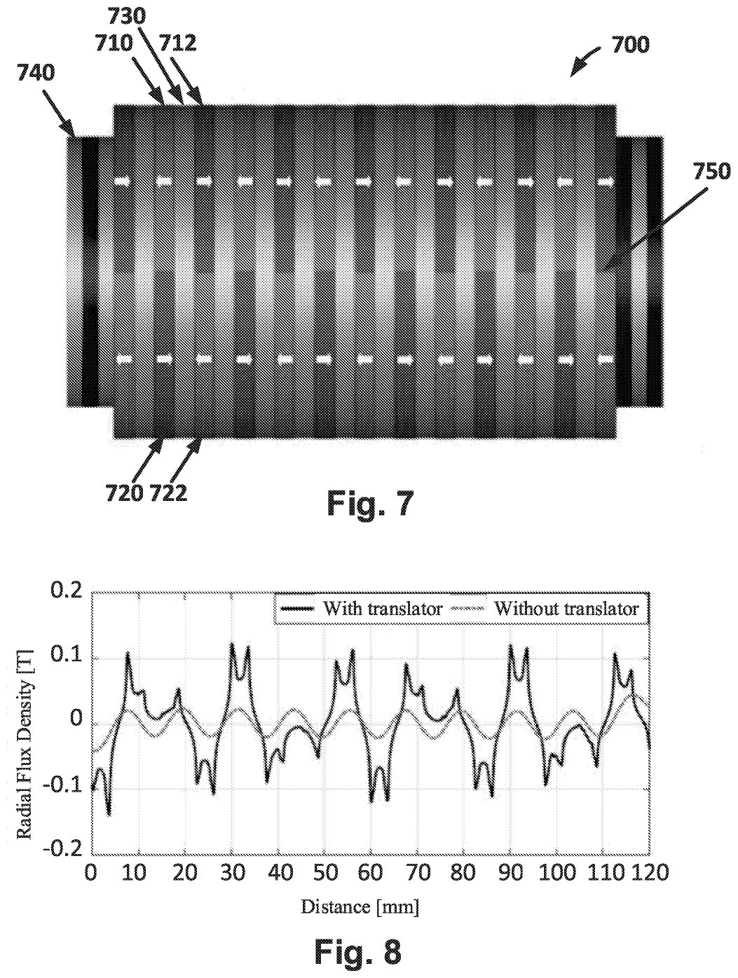

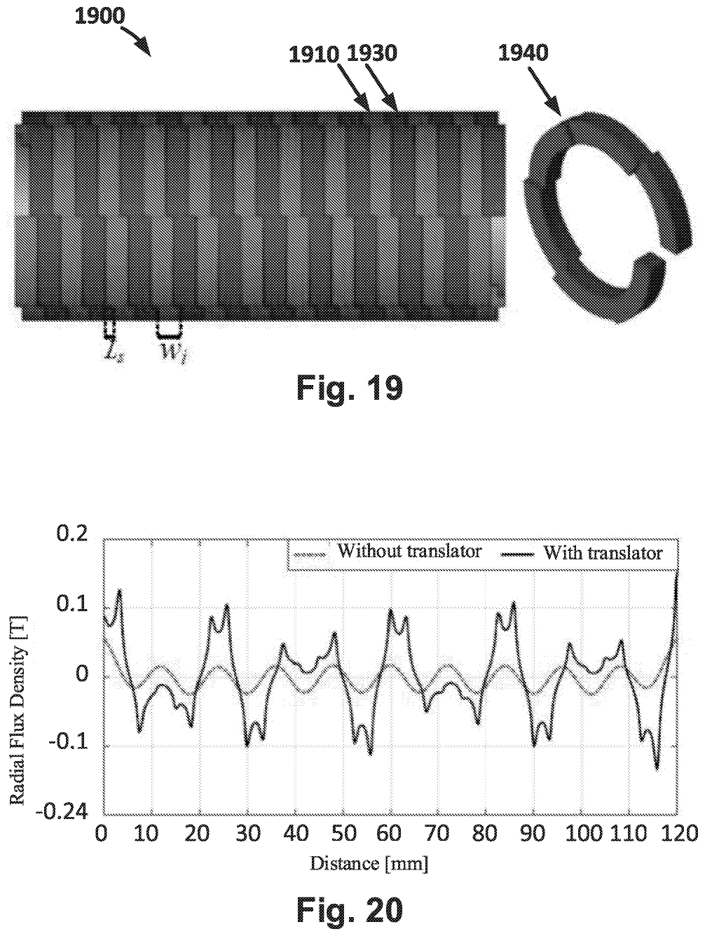

To address these issues, embodiments of a low-cost MGLS are disclosed herein, including MGLS 500 shown in FIG. 5, MGLS 700 shown in FIG. 7, and MGLS 1900 shown in FIG. 19. MGLS 500, 700, 1900 overcome the need to use skewed translator rings such as those depicted in FIG. 4 (the skewed rings of translator 320). Practically speaking, the skewed translator rings of translator 320 can be expensive to manufacture, particularly due to machining tolerances required for the orientation of the axial skewed magnetic materials on the translator 320 and the potentially relatively long length of the translator 320 relative to the inner rotor 310 and the outer cylinder 330. Instead, the MGLS 500, 700, 1900 employs skewed magnetic poles 510, 512, 520, 522 and 710, 712, 720, 722 on the outer cylinder, and/or skewed magnetic poles 1910, 1930 on the inner rotor, to achieve a comparable (and during testing, superior) effect. On the outer cylinder, a junction 550, 750 demarcates the region of skew between magnetic poles 510, 520, 710, and 720.

Although FIGS. 500 and 700 depict magnetic poles 510, 520 and 710, 720 abutting at junctions 550, 750, this is not necessarily the case. In embodiments of the disclosed technology, while the magnetic materials are desired to completely encircle the outer cylinder in a 360° fashion, it is possible for the magnetic materials to encompass a smaller portion of the outer cylinder circumference (possibly due to manufacturing tolerances, budgets, etc.). In these circumstances, it is preferable to have magnetic materials encompass no less than 180° about the outer cylinder.

The disclosed design significantly reduces the cost of the MGLS 500, 700, 1900 construction, and additionally (and unexpectedly) increases the force of the MGLS 500, 700, 1900 translator 540, 740 relative to the MGLS 300 translator 320 skewed design by as much as 20% or more as further described below.

As stated above, the low-cost MGLS 500, 700 can be realized by skewing the outer cylinder poles instead of skewing the translator 420 rings. These results are depicted in FIGS. 5 and 7 (where the skewed translator is shown by the skewed, alternating red/blue coloring or alternating grayscale shading). The skewing of the outer cylinder magnetic poles can be achieved by axially shifting magnetic half-rings 510, 512 and 710, 712 relative to oppositely polarized magnetic half rings 520, 522 and 720, 722 by zero to one axial pole pitch (2×wₒ). Alternatively, magnetic rings of any number of segments, shapes, sizes and polarizations are also encompassed within the scope of the disclosed technology. For example, any number of magnetic ring segments such as 3, 4, 5, 6, 7, 8, etc., may be used.

In FIGS. 5 and 7 each polarized magnetic half ring is separated by interposed ferromagnetic metal half rings 530, 532 or ring 730. The ferromagnetic metal can be, for example, steel. In FIGS. 5 and 7, this arrangement is depicted with magnetic half rings 510, 522 and 710, 722 (left polarized), 512, 520 and 712, 720 (right polarized), and representative ferromagnetic steel half rings 530, 532 and ring 730. In some embodiments, such as illustrated in FIG. 7, a complete pole pitch shift, (2wₒ), between lower half-rings 720, 722 and upper half-rings 710, 712 has been employed, allowing each magnetic material section (opposing polarity half-rings 710 and 720 and half-rings 712 and 722) to be directly joined and axially separated from one another by a continuous or semi-continuous band of ferromagnetic metal 730. In an embodiment, the ferromagnetic metal is ferromagnetic steel.

In one example embodiment, on which various analyses were performed, the geometric and material parameters are described by Table I below:

TABLE I
GEOMETRIC AND MATERIAL PARAMETERS

| Parameter | | Value | Unit |
|---|---|---|---|
| Outer cylinder | Pole-pairs, pₒ | 6 | — |
| (fixed)- | Outer radius, [symbol] | 40 | mm |
| not skewed | Pole-pitch, 2wₒ | 9.6 | mm |
| | Airgap length, [symbol] g | 0.5 | mm |
| | Axial length, L | 120 | mm |
| Translator rings | Ferromagnetic pieces, n [symbol] | 16 | — |
| | Outer radius, [symbol] | 32.5 | mm |
| | Radial thickness, [symbol] | 6 | mm |
| | Pole-pitch, w₂ | 3.75 | min |
| Inner rotor- | Pole pairs, p [symbol] | 10 | — |
| helically skewed | Outer radius, [symbol] | 26 | mm |
| | Pole-pitch, w [symbol] | 6 | mm |
| | Lead, λ [symbol] | 12 | mm |
| Material | NdFeB magnet, B [symbol] NMX-40CH | 1.25 | T |
| | 416 steel resistivity (translator) | 57.0 | μΩ-cm |
| | 1018 steel resistivity | 15.9 | μΩ-cm |
| | (inner, outer rotors) | | |

[symbol]

indicates data missing or illegible when filed

For this embodiment, the change in maximum translational force when the half-ring outer cylinder magnetic poles are axially shifted by an amount Lₐ is computed in FIG. 6. The maximum translator force value of Fₜₘₐₓ[N]=1444.1 N was achieved when the outer cylinder shift amount is approximately Lₐ=9 mm. However, if the half ring outer rotor is shifted by Lₐ=9.6 mm then this will equal the outer cylinder pole-pitch (2w₀) and the peak translator force only reduces by 0.4% to Fₜₘₐₓ[N]=1435 N. By choosing the half ring shift to be Lₐ=2wₒ a particularly simple design can be achieved since the outer rotor can then be made of complete ferromagnetic rings with half ring magnets, as illustrated in FIG. 7.

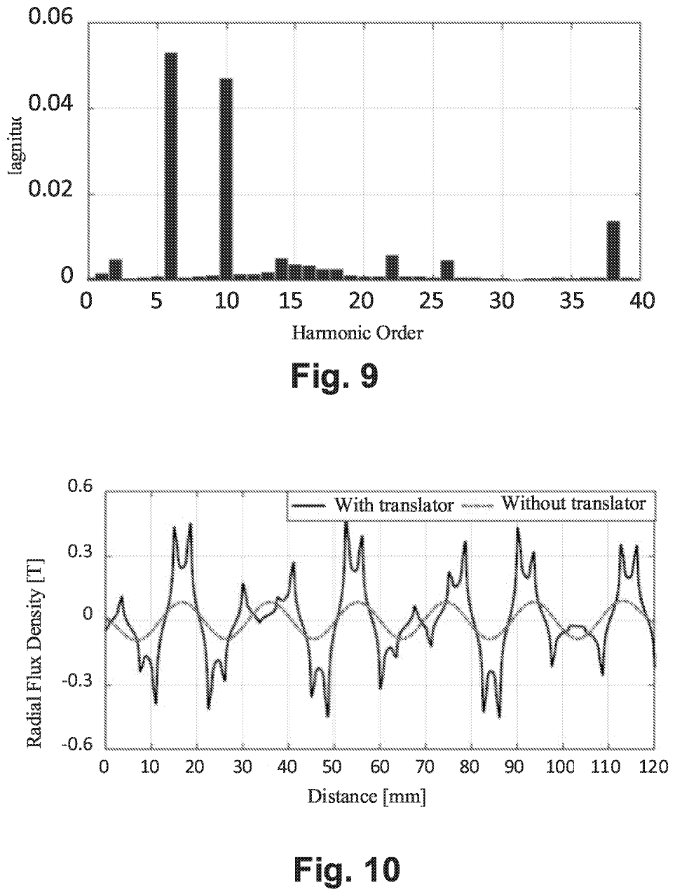

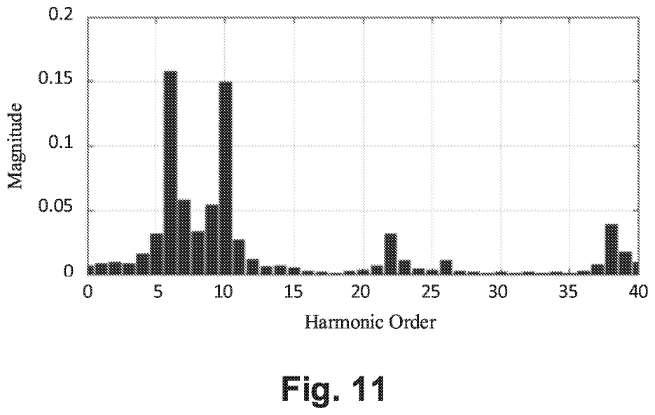

The low cost MGLS design of FIG. 5 and FIG. 7 was simulated using finite element analysis (FEA) JMAG software. The radial magnetic flux densities due to the inner rotor permanent magnets in the outer airgap along the axial length of the MGLS with and without the translator effect are shown in FIG. 8. The respective spatial harmonics created by the translator are depicted in FIG. 9, where harmonic contents of the radial flux density in the outer airgap were measured when permanent magnets were only present on the inner rotor (modulation effect of the translator). The modulation effect of the translator rings should be fairly evident. The same plots for the radial magnetic flux density in the inner airgap when magnets are only present on the outer cylinder are shown in FIGS. 10-11 respectively.

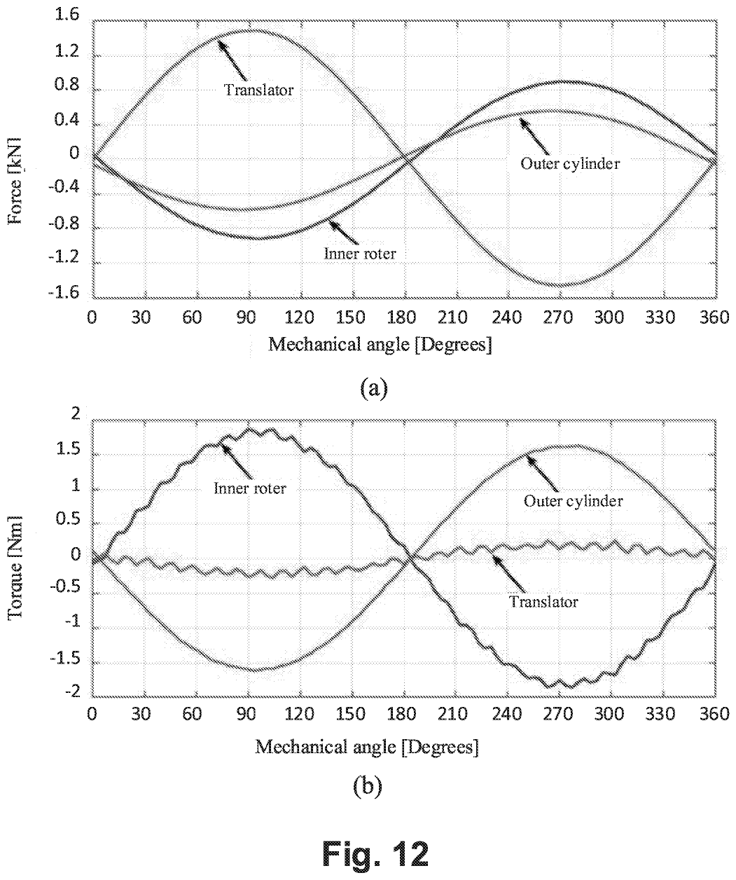

The force and torque on the different parts of a MGLS when the inner rotor is rotated by 360° while the other two parts are held stationary is calculated and shown in FIGS. 12a-b. FIG. 12a depicts force and FIG. 12b depicts torque on each MGLS part as a function of the inner rotor angular position. The values given in Table I (with Lₐ=2w₀) were used in the analysis. It was subsequently demonstrated that the relationship between translator force Fₜ and inner rotor torque Tᵢ is given by:

$${T}_{i} = - {k}_{i} ( \frac{{p}_{i}}{{n}_{t}} ) {F}_{t} \qquad ( 9 )$$

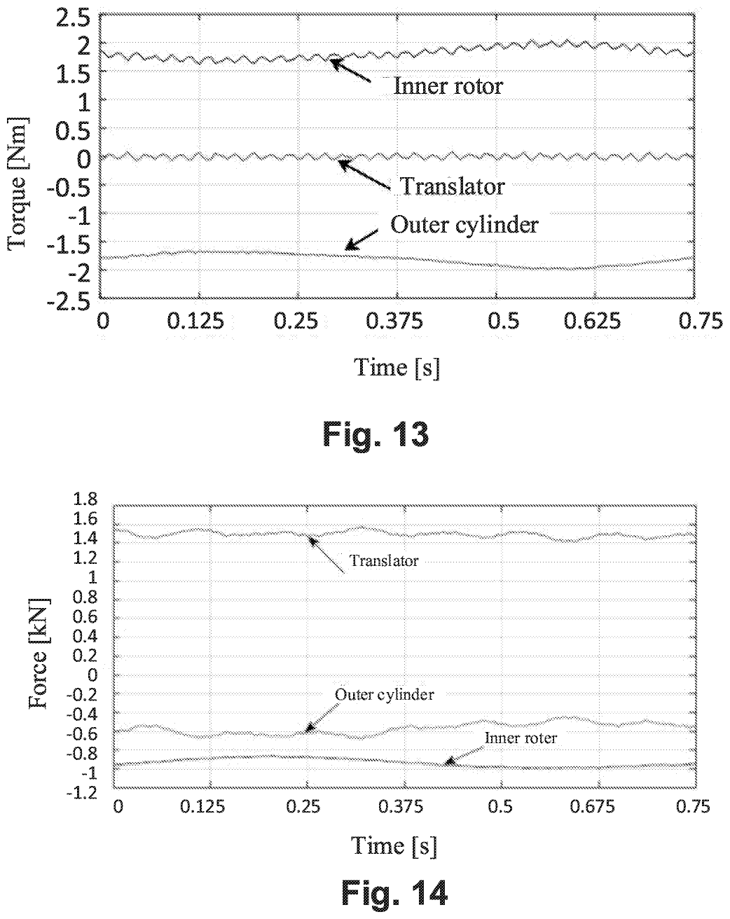

This equation shows that the gear ratio reduces the inner rotor torque required to create a translational force on the translator. Considering the inner rotor speed to be ωᵢ=80 rpm, and a translator speed of νₜ=10 mm/s, the continuous force and torque were calculated using 3-D FBA. FIG. 14 and FIG. 13 show the calculated force and torque on the different parts of a MGLS, respectively.

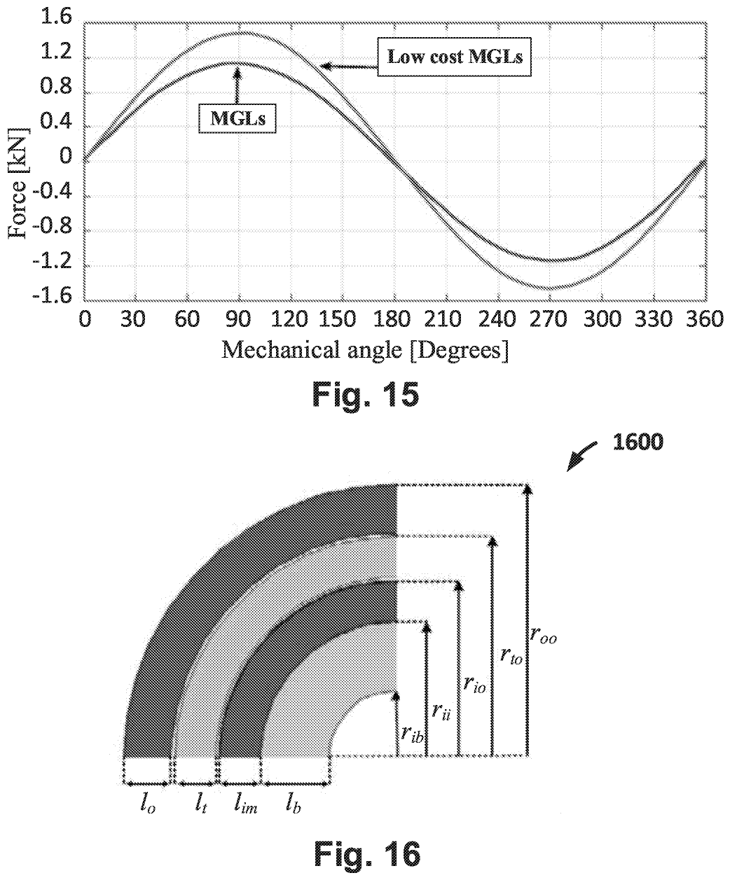

Using the same parameters as given in Table I, the translator force of the low-cost MGLS was compared with the MGLS with skewed translator. FIG. 15 shows that the translator force for the low cost MGLS is actually 23% higher than for the skewed translator design. Thus, the low cost MGLS design is low cost because the translator is only made of ferromagnetic steel rings. It has been shown that the new low cost MGLS topology is not only simpler, but also has a higher torque and force performance. As the translator does not contain magnets the cost of the MGLS for long stroke length applications, such as in marine hydrokinetic generators, should be significantly lower than for the LMG and MLS.

### III. Further Design and Experimentation Considerations

An example design of the MGLS 300 in accordance with FIG. 3 and FIG. 4 was modeled and simulated. Further, a laboratory scale MGLS prototype of the design of FIG. 3 and FIG. 4 was also built and subsequently analyzed to experimentally demonstrate the operating principal of the improved MGLS (e.g., as in FIG. 5 and FIG. 7). Various simulation results presented below show the significance of the low cost MGLS 700.

In order to maximize the force density of a MGLS, a parametric sweep analysis was performed. In this analysis, a fixed, active region volume has been considered. In this case, a fixed axial length of L=120 mm and outer MGLS radius rₒₒ=40 mm was used. A summary of the other fixed geometric parameters is given in Table II:

TABLE II
GEOMETRIC AND MATERIAL PARAMETERS

| Parameter | | Value | Unit |
|---|---|---|---|
| Outer cylinder | Pole-pairs, p [symbol] | 6 | — |
| (fixed)- | Outer radius, rₒₒ | 40 | mm |
| not skewed | Pole-pitch, 2wₒ | 9.6 | mm |
| | Airgap length, [symbol] g | 0.5 | mm |
| | Axial length, L | 120 | mm |
| Translator- | Pole pieces, n [symbol] | 21 | — |
| annular skewed | Pole-pitch, wₜ | 2.8571 | mm |
| Inner rotor- | Pole pairs, p [symbol] | 15 | — |
| helically skewed | Pole-pitch, w [symbol] | 4 | mm |
| | Lead, λ [symbol] | 8 | mm |
| Material | NdFeB magnet. B [symbol] , NMX-40CH | 1.25 | T |
| | 416 steel resistivity (translator) | 57.0 | μΩ-cm |
| | 1018 steel resistivity (inner, outer) | 15.9 | μΩ-cm |

[symbol]

indicates data missing or illegible when filed

The active region force density is calculated from:

$${V}_{Fd} = \frac{{F}_{t}}{π {r}_{oo}^{2} L} \qquad ( 10 )$$

As the geometric parameters are interrelated, only three radial parameters are needed to describe the radial geometry. They are: inner radius of inner rotor, rᵢᵢ, outer radius of inner rotor, rᵢₒ, and translator outer radius, rₜₒ. These parameters are shown in FIG. 16, which illustrates a sample cross sectional dimension for a MGLS according to some embodiments of the disclosure.

Table III shows the results of the iterative method, which was used to maximize the force density:

TABLE III
ITERATION OF RADIAL PARAMETERS

| Iteration | | | | | | | | | |
|---|---|---|---|---|---|---|---|---|---|
| number | | 0 | I | II | III | IV | V | Vₚ | Unit |
| Inner | Outer | 31 | 31 | 31 | 30 | 30 | 30 | 26 | mm |
| rotor | radius, rᵢₒ | | | | | | | | |
| | Inner | 29 | 29 | 25 | 25 | 22 | 22 | 20 | mm |
| | radius, rᵢᵢ | | | | | | | | |

| | | | | | | | | |
|---|---|---|---|---|---|---|---|---|
| Translator outer | 37.5 | 33.5 | 33.5 | 32.5 | 32.5 | 32.5 | 32.5 | mm |
| radius, rₜₒ | | | | | | | | |
| Translator bar | 6 | 2 | 2 | 2 | 2 | 2 | 6 | mm |
| thickness, lₜ | | | | | | | | |
| Outer rotor | 38 | 34 | 34 | 33 | 33 | 33 | 33 | mm |
| inner radius rₒᵢ | | | | | | | | |
| Translator | 0.76 | 1.76 | 1.84 | 1.85 | 1.88 | 1.88 | 1.06 | kN |
| force, Fₜ | | | | | | | | |
| Volumetric | 1.1 | 2.92 | 3.06 | 3.07 | 3.13 | 3.13 | 1.82 | kN/L |
| force density | | | | | | | | |
| Force-per-kg | 1.15 | 1.75 | 1.14 | 1.2 | 0.97 | 0.97 | 0.84 | kN/ |
| magnet, Fₖₒ | | | | | | | | kg |

In iteration I, rᵢᵢ was fixed and a parametric sweep of rᵢₒ and rₜₒ was performed. The values of parameters were then fixed in iteration II, and a parametric sweep for rᵢᵢ was performed. This procedure was repeated until no significant improvement was obtained. The maximum volumetric force density for this design was determined to be 3.13 kN/L, as can be seen in iteration IV.

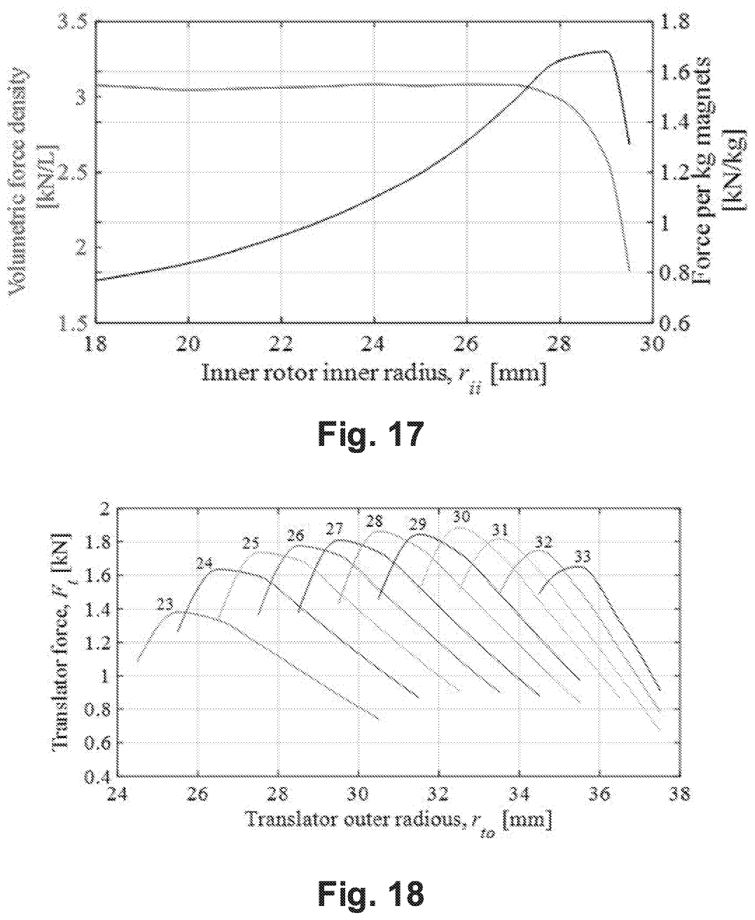

FIG. 17 shows a trade-off between maximizing volumetric force density and force-per-kg of magnet materials as a function inner rotor inner radius for iteration IV. Translation force as a function of the inner rotor outer radius rᵢₒ and the translator outer radius rₜₒ for iteration V is plotted in FIG. 18.

It can be desirable to have ample radial thickness for the translator rings. In this instance, a design with a larger translator radial thickness 6 mm was selected instead of the preferred design achieved under iteration Vₚ in Table III.

Making ideal helical structures for the inner rotor 1900 can be difficult. Accordingly, and as shown in FIG. 19, a discretized helix 1940 can be used instead. Specifically, FIG. 19 illustrates a side view of a segmented inner rotor 1900 composed of radially outward-polarized magnetic rings 1910 and radially inward-polarized magnetic rings 1930 offset laterally, forming a more easily manufactured discrete assembly. In an isolated discretized helix 1940, 60° degree magnet arcs were considered to accommodate this architecture. As seen in FIG. 19, element 1940, each helix is formed by 6 segments displaced longitudinally with respect to the adjacent segments. With an axial length of 120 mm and a constraint of 15 inner rotor 1900 pole-pairs, the axial thickness of these example magnet segments is 4 mm, which is too thin for most practical applications, because (1) thin magnets are prone to break more easily, and (2) the magnets need to be shifted/skewed with respect to their adjacent magnets. Having a small thickness thus makes it exceptionally difficult, if not costly, to assemble.

In view of these obstacles, it is desirable to either have a very small axial shift (e.g., less than 1 mm), which is difficult, or to have a smaller number of magnet pieces per one helix turn (e.g., use a larger arc angle), which makes the helix approximation less reliable. Considering these facts, a trade-off can be employed. For example, for one example embodiment, the pole-pairs combination was changed from pᵢ=15, pₒ=6, and nₜ=21 to pᵢ=10, pₒ=6, and nₜ=16. For this combination, the axial thickness of the magnet pieces is now 6 mm (compared to the previous 4 mm axial thickness), which is more manageable. The amount of shift, Lₛ, generally depends on the axial thickness of each piece wᵢ as well as the number of pieces in one helix turn, n. Accordingly, the shift Lₛ can be calculated as:

$${L}_{S} = ( \frac{{w}_{i}}{\frac{n}{2}} ) = ( \frac{6}{\frac{6}{2}} ) = 2 mm \qquad ( 11 )$$

As stated above, the example segmented helical rotor 1940 is shown in FIG. 19. In order to avoid using thin pieces of magnets at two ends, which can be difficult to fabricate, the rotor back-iron was extended by 5 mm from both sides, and magnets with approximately the same size were used at the both ends.

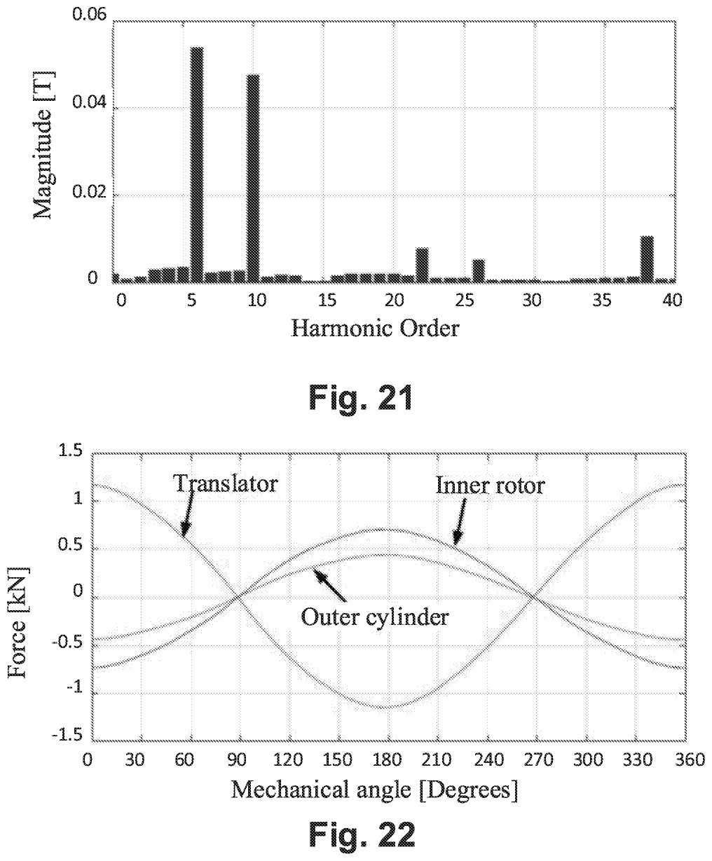

Using the final values of the parametric sweep, and applying some practical related changes, the radial flux density due to the inner rotor 1900 permanent magnets near the outer cylinder were evaluated. The results are shown in FIG. 20, which depicts radial flux densities in the outer air-gap due to magnets only on the inner rotor 1900. The corresponding spatial harmonics, when the translator (e.g., translator 320) is present, is also shown in FIG. 21 (harmonic values of radial flux densities in the outer air-gap due to magnets only on the inner rotor 1900 (translator modulation)). The modulation effect of the translator in FIG. 20 is fairly evident.

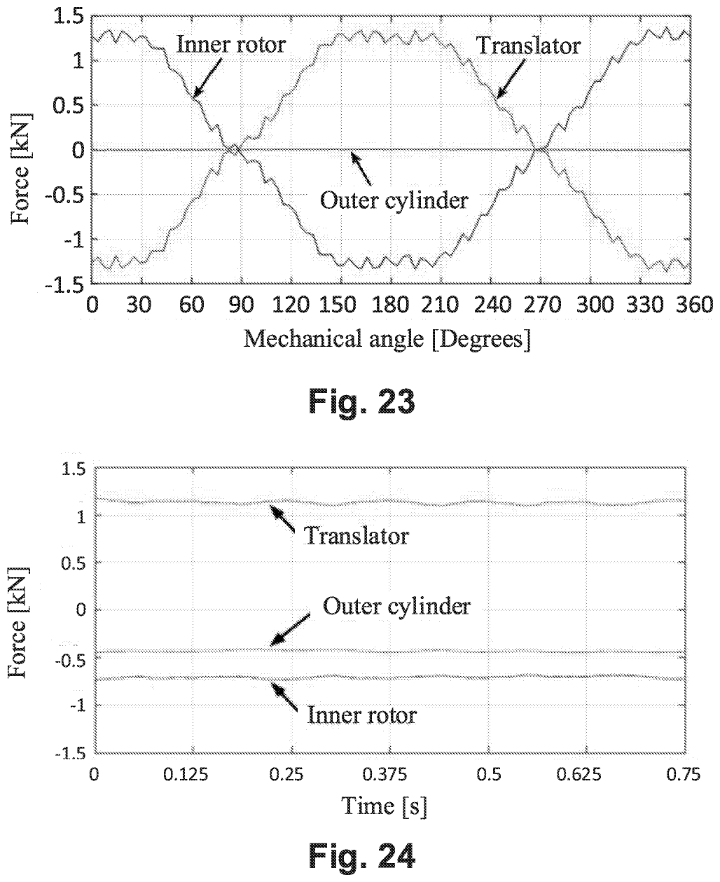

Rotation of the inner rotor 1900, while the other two parts of the MGLS—the translator (such as translator 320) and the outer cylinder are kept stationary created an axial force and torque on different parts of the MGLS. FIG. 22 and FIG. 23 show the pole slippage force and torque on the different parts of the MGLS, respectively. It can be shown that the net force satisfies:

Fᵢ+Fₒ+Fₜ=0 (12)

where Fᵢ=inner rotor force, Fₒ=outer cylinder force, and Fₜ=translator force. Torque is only created on the inner rotor 1900 and the translator because they are skewed. Thus, these torques satisfy:

Tᵢ+Tₜ=0 (13)

where Tᵢ and Tₜ are the torque on the inner rotor and translator, respectively. Assuming no losses the power flow relationship may now satisfy:

Tᵢωᵢ+Fₜνₜ=0 (14)

By substituting the previously disclosed speed relationship into eq. (14) and neglecting losses, it can be shown that:

$${T}_{i} = - {F}_{t} {k}_{i} ( \frac{{p}_{i}}{{n}_{t}} ) \qquad ( 15 )$$

Equation (15) shows that the gear ratio reduces the torque needed to create the translational force.

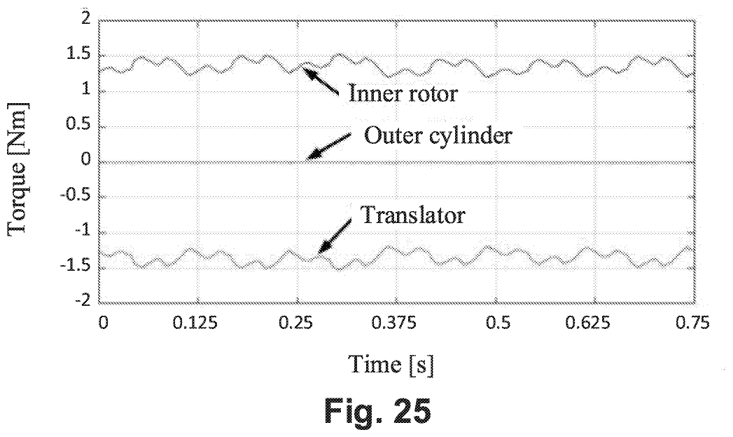

Accordingly, rotation of the inner rotor 1900 and the translator (e.g., translator 320) at the same time by the speed of 80 rpm and 10 mm/s, respectively, will create a constant force and torque, which were calculated using 3-D finite element analysis (FEA) software. The results are depicted in FIG. 24 (force on different parts of the example MGLS due to rotation of the inner rotor 1900 and translation of the translator at the same time), and FIG. 25 (torque on different parts of the example MGLS due to rotation of the inner rotor 1900 and translation of the translator at the same time), respectively.

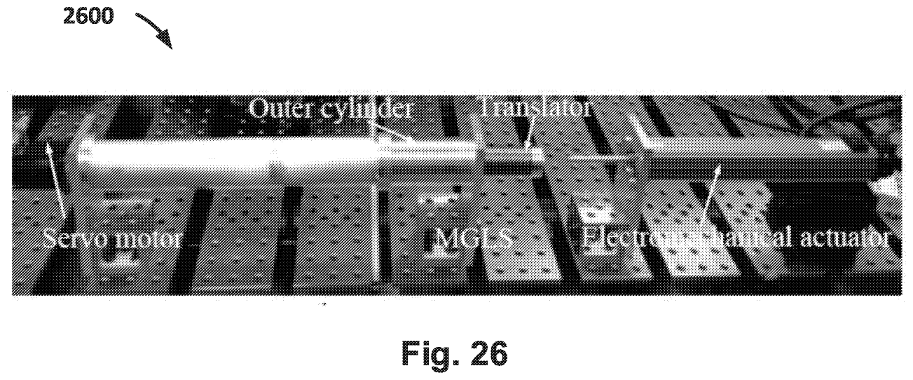

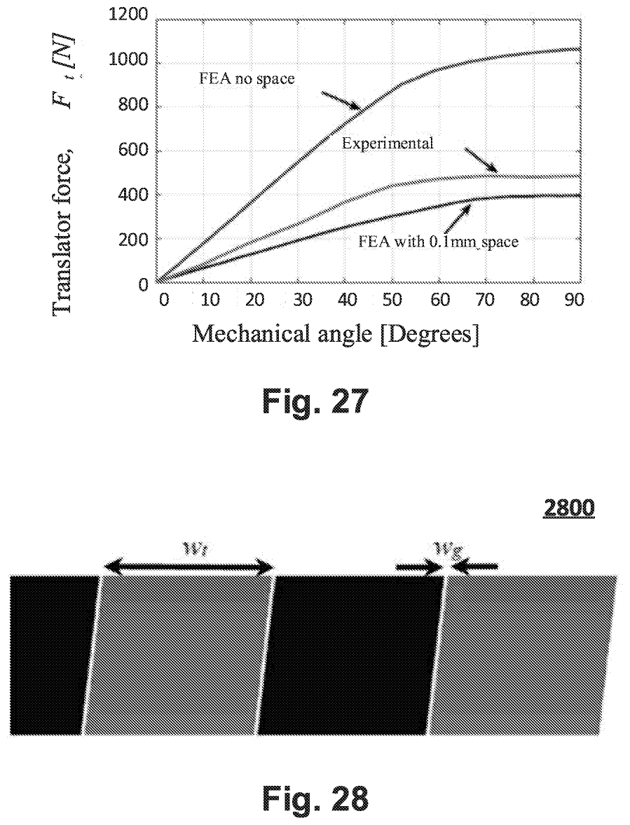

The numerically modelled MGLS was then constructed. FIG. 26 is an image showing the example MGLS 2600 on the test bed. The inner rotor has been rotated manually for 90 degrees while the translator has been kept stationary. Using a load cell, the force on the translator was measured. FIG. 27 shows the measured force on the translator compared with the calculated force using finite element analysis (FEA).

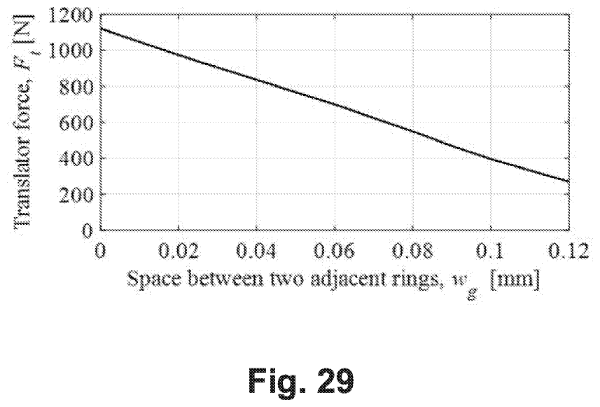

It can be seen the measured force of the MGLS 2600 is considerably lower than the predicted force. Further investigation has shown that the force capability of the MGLS 2600 is very sensitive to the space between ferromagnetic pole-pieces of the translator. As the steel and plastic rings of the example translator are held together using 4 plastic rods in the structure of the example MGLS 2600, and in consideration of existing manufacturing tolerances, a small space between the rings could be expected. In recognition of this, an FEA analysis has been performed to calculate the effect of spacing between translator rings. A small space of w_{g}=0.1 mm was considered as shown in FIG. 28. FIG. 27 shows that a 2.6% increase in the space between steel rings can result in a near 60% reduction of thrust force. FIG. 29 shows the variation of the translator force due to the effect of this small space. This reduction is consistent with a sensitivity to tolerance previously seen in other LMGs.

### IV. Further Embodiments

### IV.A. Brief Overview

Linear actuation is often achieved by utilizing either a hydraulic or mechanical gearing mechanism. Hydraulic actuators have been shown to be able to operate with force densities on the order of 35 MPa. However, hydraulic and mechanical gearing mechanisms can suffer from poor efficiency and low reliability and often need regular servicing. Electromagnetic linear actuators (ELAs) have been extensively studied as a means of increasing both the reliability and efficiency of a linear actuator. However, as the force density of an ELA is constrained by the current density the force density of proposed designs have not attained values higher than around 0.6 MPa. Recently linear magnetic gearboxes (LMG) and magnetic lead screws (MLS) have been proposed as a means of increasing this force density. The LMG and MLS create force using only magnetic loading and therefore a very high magnetic air-gap shear stress can be sustained.

In some embodiments, the disclosed embodiments comprise a new type of high force density magnetically geared lead screw. It is shown that by using a helical inner and an annularly skewed ring translator a rotational motion can be converted into a magnetically geared translational motion. In particular embodiments, the disclosed designs provide the advantage that all (or most) of the magnets are continuously utilized to create the magnetically geared translational force.

### IV.B. Detailed Description of Further Example Embodiments

Embodiments of the disclosed technology will now be described more fully hereinafter in the following detailed description of the disclosed technology, in which some, but not all embodiments of the invention are described. Indeed, the disclosed technology may be embodied in many different forms and should not be construed as limited to the embodiments set forth herein; rather, these embodiments are provided so that this disclosure will satisfy applicable legal requirements.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the disclosed technology, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion.

Linear actuation is often achieved by utilizing either a hydraulic or mechanical gearing mechanism. Hydraulic actuators have been shown to be able to operate with force densities on the order of 35 MPa. However, hydraulic and mechanical gearing mechanisms can suffer from poor efficiency and low reliability and often need regular servicing. Electromagnetic linear actuators (ELAs) have been extensively studies as a means of increasing both the reliability and efficiency of a linear actuator. However, as the force density of an ELA is constrained by the current density the force density of proposed designs have not attained values higher than around 0.6 MPa. Recently linear magnetic gearboxes (LMG) and magnetic lead screws (MLS) have been proposed as a means of increasing this force density. The LMG and MLS create force using only magnetic loading and therefore a very high magnetic air-gap shear stress can be sustained.

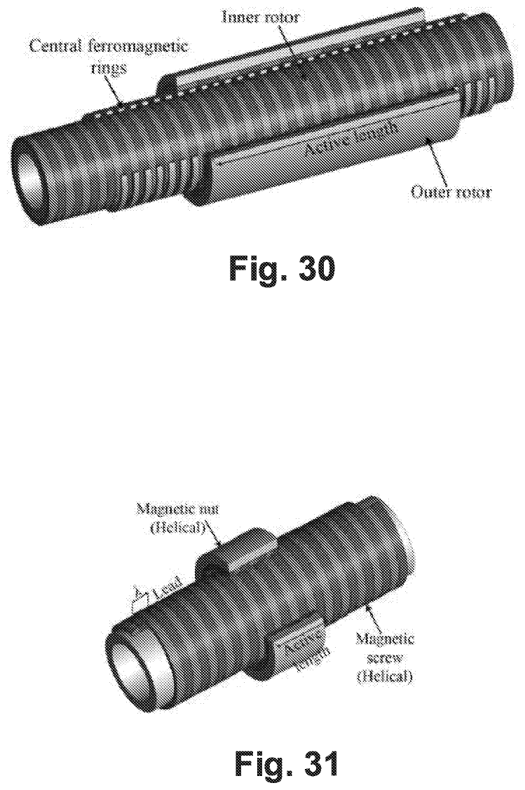

An example of a LMG is shown in FIG. 30; the LMG utilizes magnetic field heterodyning to create linear motion speed change without any physical contact. The LMG comprises three concentric tubular parts, an outer rotor containing, pₒ pole-pairs that can move with a translational velocity νₒ an inner rotor containing pᵢ pole-pairs that can move at velocity νᵢ and a central section that contains nₜ ferromagnetic rings. The rings can move at velocity νₜ. The ferromagnetic rings modulate the permanent magnet (PM) fields and therefore by choosing:

nₜ=pₒ+pᵢ (16)

the speed relationship between the translating moving parts will be:

νₜnₜ=νᵢpᵢνₒpₒ (17)

If ν₀=0 the gear ratio will then be Gᵣ=νₜ/νᵢ=pᵢ/nₜ. It has been demonstrated that a 3.25:1 gear ratio LMG is capable of operating with a force density of over 2 MPa. By mating a stator winding with the LMG a relatively high force density magnetically geared actuator can be created. The LMG has been investigated for use in ocean power generation applications as well as for vehicle suspension.

An example of a MLS is shown in FIG. 31. The MLS converts linear motion to rotary motion using helically shaped magnets. The principle of operation of the MLS is analogous to a mechanical nut and screw but with a magnetic rotating “screw” and a magnetic translating “nut”. Both parts are made of helically disposed radially magnetized PMs on the inner and outer steel yokes.

The relationship between the translating velocity and angular velocity is given by:

$$v = \frac{λ}{2 π} ω \qquad ( 18 )$$

where λ=lead of the rotor. Wang calculated that the MLS could achieve force densities in excess of 10 MPa. Recently, the performance of a 17 kN MLS has been experimentally verified for a wave energy converter, and a test with an MLS has been performed for active vehicle suspension.

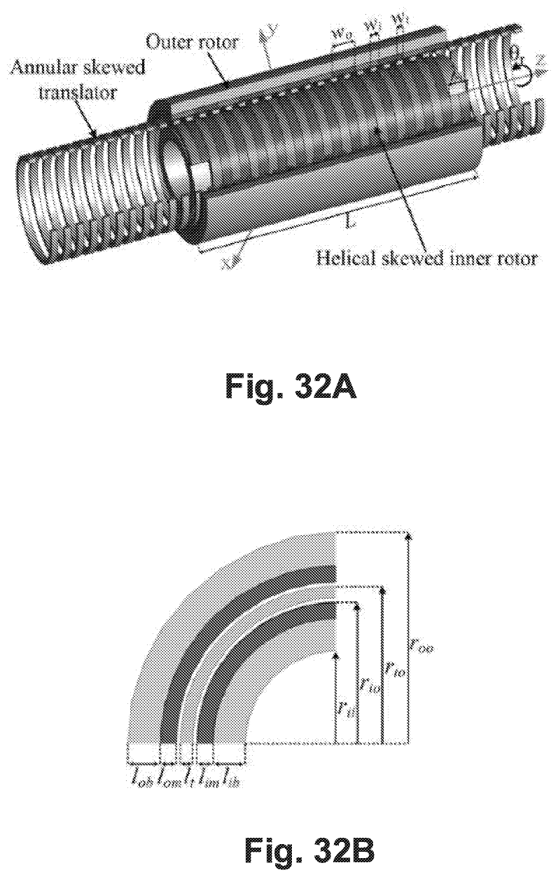

Both the LMG and MLS topologies desirably have the quality that one of the linear translating parts be made of magnet material and therefore if the linear stroke length is large then only a small portion of the magnet material will be utilized at any given time. Therefore, this will result in a low force-per-kilogram of magnet usage and consequently the design will be costly to build. In order to address this issue, in this disclosure, a new type of magnetically geared lead screw (MGLS), as shown in FIG. 32A is proposed, where long-stroke translator is made of ferromagnetic material.

The MGLS in FIG. 32A comprises three concentric tubular parts: an inner rotor with pᵢ helically skewed, radially magnetized PM pole-pairs. An outer rotor with pₒ radially magnetized PM pole-pairs, which are in a ring and a translator which contains nₜ ferromagnetic annular skewed pole pieces. Due to the helical magnetization on the inner rotor, when the inner rotor is rotated, it will create a travelling field along the z-axis. This translating field will be modulated by the ferromagnetic pole pieces and therefore create additional spatial harmonics. The spatial harmonics will then interact with the outer rotor field. A constant translational force, F_{z} will be created only when (1) is satisfied. The rotation of the inner rotor with angular velocity, ωᵢ, will create a translational velocity, vi, given by:

$$\begin{matrix}{v}_{i} = {k}_{i} {ω}_{i} \\ where & ( 19 ) \\ {k}_{i} = \frac{{λ}_{i}}{2 π} & ( 20 )\end{matrix}$$

and λᵢ=inner rotor lead, which is twice the magnet pole-pitch. When the outer rotor is stationary the linear translator speed, νₜ can be calculated from (17) and the speed relationship is:

$${v}_{t} = {v}_{i} \frac{{p}_{i}}{{n}_{t}} \qquad ( 21 )$$

For the case when pi=15, nt=21 the gear ratio is then Gr=pi/nt=1.4. Substituting (19) into (20) gives:

$${v}_{t} = \frac{{k}_{i} {p}_{i}}{{n}_{t}} {ω}_{i} \qquad ( 22 )$$

This equation relates the rotation speed of the inner rotor with the translational speed. The operation of the MGLS is similar to that of the MLS however the translator is entirely made of low-cost steel.

### IV.C. Further Analyses

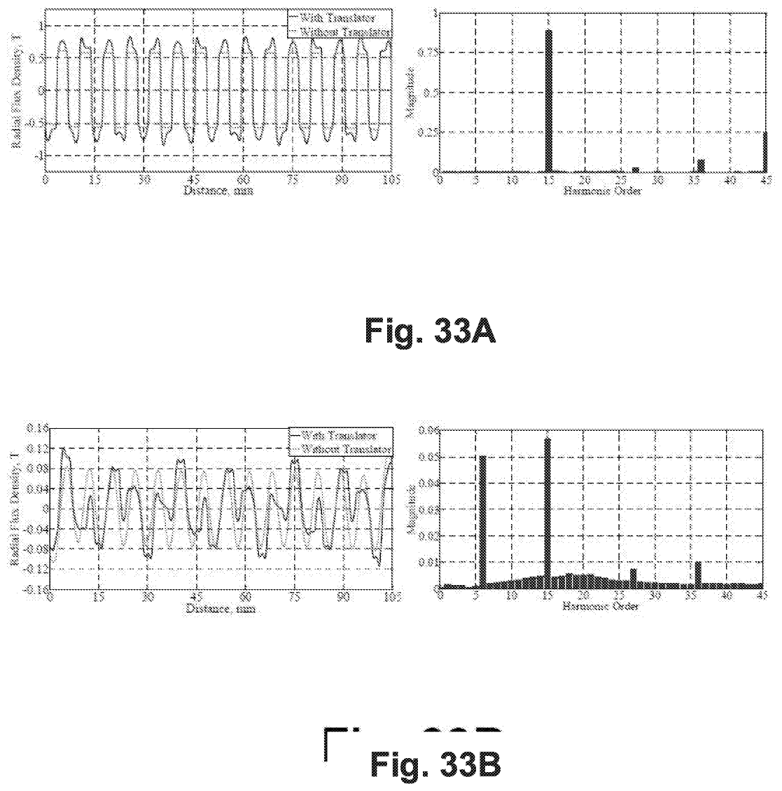

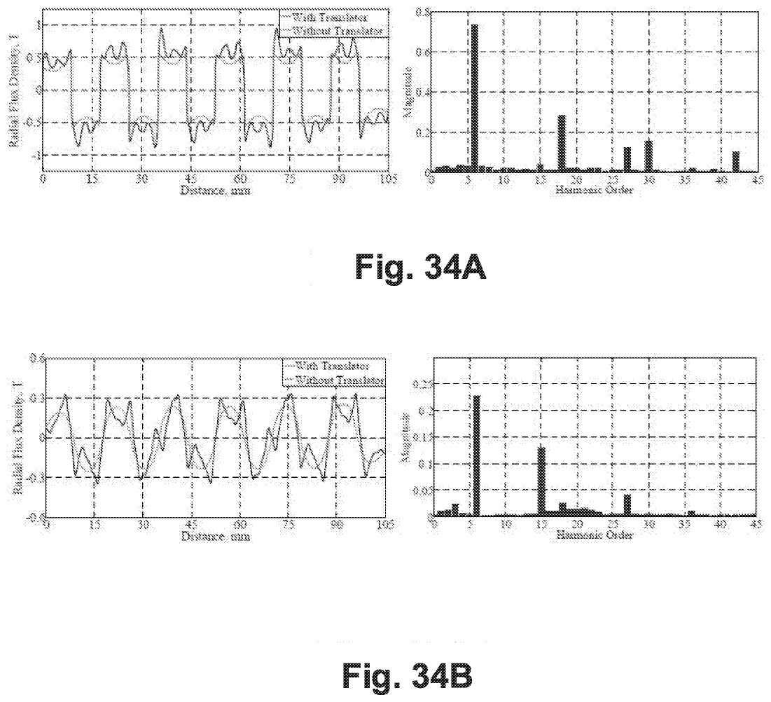

The characteristics of the proposed MGLS have been investigated by using a 3-D finite element analysis (FEA) magnetostatic model. Using the values given in Table IV, the radial flux density due to the inner rotor PMs near the inner rotor and the outer rotor have been evaluated. The results are shown in FIG. 33A; the corresponding spatial harmonics, when the translator is present, is also shown. FIG. 33B shows the same plots when the PMs are only present on the outer rotor. The modulation effect of the translator is clearly evident.

FIG. 32A shows a structure of proposed magnetically geared linear screw and FIG. 32B shows the cross-sectional dimensional values.

TABLE IV
SUMMARY OF DESIGN PARAMETERS

| Parameter | | Value | Unit |
|---|---|---|---|
| Outer rotor | Pole-pairs, p [symbol] | 6 | — |
| (fixed)-not | Outer radius, [symbol] | 26 | mm |
| skewed | Back iron. [symbol] | 4 | mm |
| | Magnet thickness, [symbol] | 2 | mm |
| | Pole-pitch, w [symbol] | 8.75 | mm |
| | Airgap length. [symbol] g | 0.5 | mm |
| | Axial length, L | 105 | mm |
| | Pole pieces, n [symbol] | 21 | |
| Translator- | Outer radius, [symbol] | 19.5 | mm |
| annular skewed | Steel thickness, [symbol] | 1.5 | mm |
| | Pole-pitch, w [symbol] | 2.5 | mm |
| | Pole pairs, p [symbol] | 15 | — |
| | Inner radius, [symbol] | 11.5 | mm |
| | Outer radius. [symbol] | 17.5 | mm |
| Inner rotor- | Back iron, [symbol] | 4 | mm |
| helically skewed | Magnet thickness, [symbol] | 2 | mm |
| | Pole-pitch, w [symbol] | 3.5 | mm |
| | Lead, [symbol] | 7 | mm |
| Material | NdFeB magnet, Hitachi NMX- | 1.25 | T |
| | 40CH | | |
| | 416 steel resisitivity (translator) | 57.0 | μΩ-cm |
| | 1018 stee1 resistivity (back iron) | 15.9 | μΩ-cm |

[symbol]

indicates data missing or illegible when filed

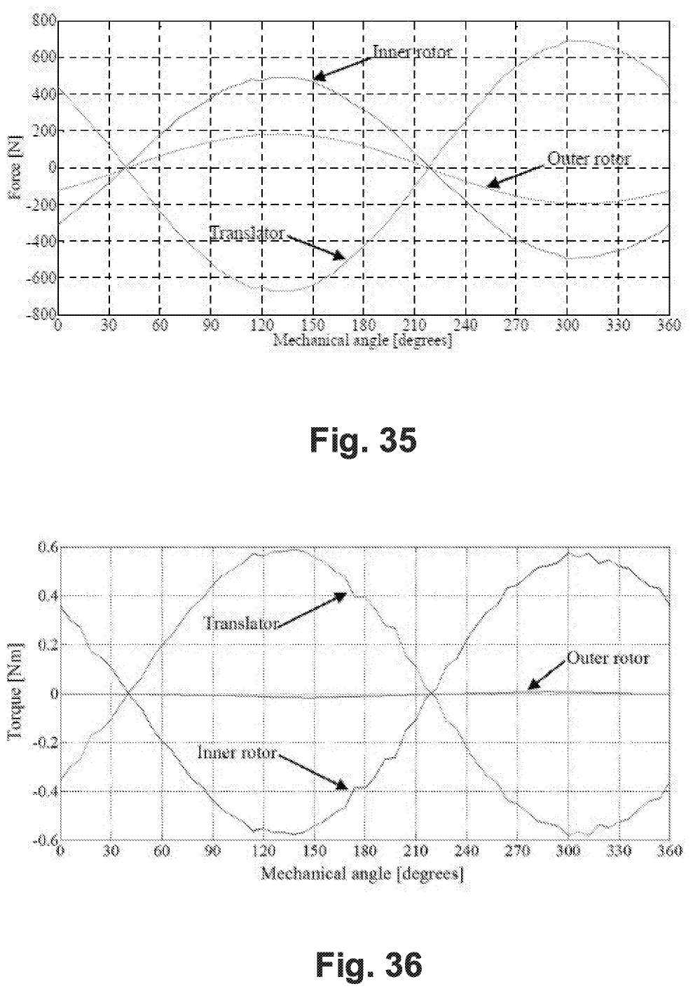

When the inner rotor is rotated by 360 degree, while the outer rotor and translator are kept stationary an axial force along the z-axis is created as well as a torque. FIG. 35 shows the calculated forces when using the parameters given in Table 4. It can be noted the net force on the three parts must satisfy:

Fᵢ+Fₒ+Fₜ=0 (23)

where Fᵢ=inner rotor force, Fₜ=translator force, Fₒ=outer rotor force. The torque on the MGLS components is shown in FIG. 36, where it can be noted that because the helical structure of the inner rotor and the translator's annular skew a torque is created only on these two parts. The outer rotor does not experience any torque since it is not skewed. The torque will therefore satisfy:

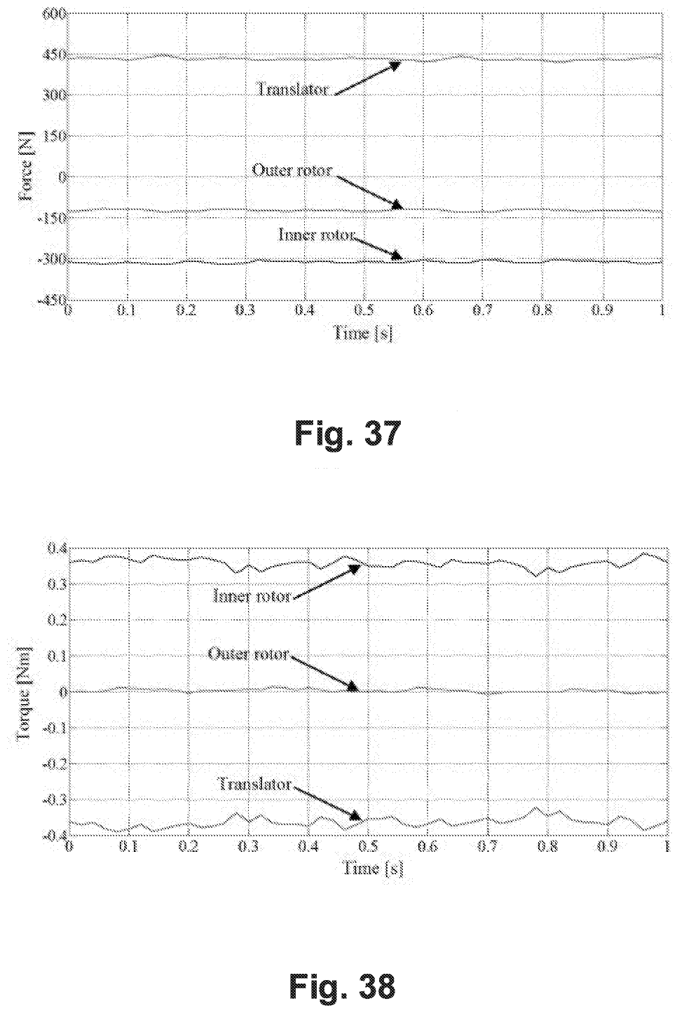

Tᵢ+Tₜ=0 (24)

where Tᵢ and Tₜ are the torque on the inner rotor and translator respectively. By having both rotation of the inner rotor and translation of the translator at the same time a constant force in the z-direction can be created. The force and torque on the different parts when ω₀=60 rpm and νₜ=5 mm/s is shown in FIGS. 37 and 38, respectively. Assuming no losses the power flow relationship will satisfy:

Fₜνₜ+Tᵢωᵢ=0 (25)

FIG. 37 is a graph showing force along the z-direction on different parts due to rotation of inner rotor.

FIG. 38 shows torque on different parts due to rotation only on the inner rotor and by substituting (22) into (25) and rearranging one obtains:

$${T}_{i} = {F}_{t} \frac{{k}_{i} {p}_{i}}{{n}_{t}} \qquad ( 26 )$$

Therefore, the gear ratio reduces the torque needed to create the translational force.

FIG. 37 shows the force in the z-direction on the different parts due to rotation of inner rotor and translation of translator at the same time.

This disclosure has presented a new type of MGLS that can be utilized for linear actuation. One of the advantages of the proposed MGLS over prior-art designs such as LMG and MLS is that the MGLS translator does not need to be made from magnetic material and therefore the cost of the actuator, especially when used in long stroke applications should be significantly lower.

### V. Conclusion

In view of the many possible embodiments to which the principles of the disclosed invention may be applied, it should be recognized that the illustrated embodiments are only preferred examples of the invention and should not be taken as limiting the scope of the invention.

1. A magnetically geared lead screw, comprising:
a cylindrical inner rotor configured to rotate about a central axis, the outer surface of the inner rotor including inner rotor magnetic portions of alternating polarity;
a cylindrical translator that circumferentially surrounds the inner rotor, the cylindrical translator comprising non-helical ferromagnetic rings that are radially unskewed relative to the central axis, the cylindrical translator being linearly translatable along the central axis; and
an outer cylinder that circumferentially surrounds both the cylindrical translator and the cylindrical inner rotor, the surface of the outer cylinder including outer cylinder magnetic portions of alternating polarity, at least a portion of the outer cylinder magnetic portions of alternating polarity being linearly offset from one another along the central axis.

2. The magnetically geared lead screw of claim 1, wherein the inner rotor magnetic portions are disposed helically along the outer surface of the inner rotor.

3. The magnetically geared lead screw of claim 1, wherein the inner rotor magnetic portions form a helical shape on the outer surface of the inner rotor formed from individual non-helical magnetic portions being linearly offset along the central axis from adjacent non-helical magnetic portions.

4. The magnetically geared lead screw of claim 1, wherein the outer cylinder magnetic portions comprise magnetic half rings.

5. The magnetically geared lead screw of claim 1, wherein the outer cylinder magnetic portions comprise three or more ring portions that together form a complete loop around the outer cylinder.

6. A magnetically geared lead screw, comprising:
a cylindrical inner rotor configured to rotate about a central axis, the surface of the inner rotor including inner rotor magnetic portions of alternating polarity, wherein the inner rotor magnetic portions form a helical shape on the outer surface of the inner rotor;
a cylindrical translator that circumferentially surrounds the inner rotor, the cylindrical translator comprising non-helical ferromagnetic rings that are radially unskewed relative to the central axis, the cylindrical translator being linearly translatable along the central axis; and
an outer cylinder that circumferentially surrounds both the cylindrical translator and the cylindrical inner rotor, the surface of the outer cylinder including outer cylinder magnetic portions of alternating polarity

7. The magnetically geared lead screw of claim 6, wherein the helical shape of the cylindrical inner rotor is formed from individual non-helical magnetic portions being linearly offset along the central axis from adjacent non-helical magnetic portions.

8. The magnetically geared lead screw of claim 6, wherein at least a portion of the outer cylinder magnetic portions of alternating being linearly offset from one another along the central axis.

9. The magnetically geared lead screw of claim 8, wherein the outer cylinder magnetic portions comprise magnetic half rings.

10. The magnetically geared lead screw of claim 8, wherein the outer cylinder magnetic portions comprise magnetic ring portions comprise three or more ring portions to form a complete loop around the outer cylinder.

11. A device configured to convert energy between linear and rotational motion, comprising:
an outer cylinder comprising:
a plurality of magnetic materials radially disposed on the outer cylinder having a first magnetic polarization;
a plurality of magnetic materials radially disposed on the outer cylinder having a second magnetic polarization, the second magnetic polarization being different from the first magnetic polarization;
an inner rotor comprising:
a third portion of magnetic material disposed radially along the inner rotor and having a third magnetic polarization, the third magnetic polarization being different from the first and second magnetic polarization; and
a fourth portion of magnetic material disposed radially along the inner rotor and having a fourth magnetic polarization, the fourth magnetic polarization being different from the first, second and third magnetic polarization; and
a translator comprising:
at least one ring comprising a ferromagnetic material,
wherein a pole of a magnetic material having the first magnetic polarization is axially offset from a pole of a nearest second magnetic material of the first magnetic polarization by a predetermined amount.

12. The device of claim 11, further comprising a ferromagnetic material disposed radially along the outer cylinder and at least partially positioned between a magnetic material having the first magnetic polarization and a magnetic material having the second magnetic polarization.

13. The device of claim 12 wherein the ferromagnetic material is ferromagnetic steel.

14. The device of claim 11, wherein a combination of one or more magnetic materials of the first magnetic polarization and one or more magnetic materials of the second magnetic polarization are radially disposed 360° about the circumference of the outer cylinder.

15. The device of claim 11, wherein the displacement between magnetic materials of the first magnetic polarization and magnetic materials of the second magnetic polarization is twice the magnetic pole pitch wₒ of the outer cylinder.

16. The device of claim 11, wherein the at least one translator ring is comprised of ferromagnetic steel.

17. The device of claim 11, wherein the at least one translator ring is substantially circular, centered along a transverse axial dimension of the outer cylinder, and wherein a portion of the at least one translator ring furthest from the axial translator axis is substantially perpendicular to the center of the at least one translator ring.

18. The device of claim 11, wherein the at least one translator ring is not translationally skewed relative to the axis of the translator.

19. The device of claim 11, wherein magnetic materials of the first magnetic polarization and magnetic materials of the second magnetic polarization comprise magnetic half-rings of opposing polarity.

20. The device of claim 11 wherein the at least one translator ring is continuously connected along its circumference.

21. The device of claim 11 wherein an individual ferromagnetic ring is formed of segmented ferromagnetic pieces.

22. A device configured to convert energy between linear and rotational motion, comprising:
an outer cylinder comprising:
a first portion of magnetic material radially disposed on no less than 180° of the circumference of the outer cylinder and having a first magnetic polarization; and
a second portion of magnetic material radially disposed on no less than 180° of the circumference of the outer cylinder and having a second magnetic polarization, the second magnetic polarization being different from the first magnetic polarization;
wherein a magnetic pole of each of the first and second portions are substantially parallel along the circumference of the outer cylinder, and the magnetic pole of each of the first and second portions is displaced at a terminating end of each of the first and second portions by a predetermined amount.

23. The device of claim 22, further comprising:
an inner rotor comprising:
a third portion of magnetic material disposed axially along the inner rotor and having a third magnetic polarization, the third magnetic polarization being different from the first and second magnetic polarization; and
a fourth portion of magnetic material disposed radially along the inner rotor and having a fourth magnetic polarization, the fourth magnetic polarization being different from the first, second and third magnetic polarization; wherein
the third and fourth portions of magnetic material are in continuous contact about the circumference of the inner rotor.

24. The device of claim 23, wherein at least one of the third and fourth portions of magnetic material comprise discrete, segmented magnetic materials.

25. The device of claim 24 where the number of segments is six, and each segment is partially offset from each neighboring segment.

26. The device of claim 22, further comprising a translator disposed between the outer cylinder and inner rotor comprising ferromagnetic materials.

27. The device of claim 26, wherein the ferromagnetic materials comprise ferromagnetic steel.

28. The device of claim 22, wherein the displacement of the terminating ends of the first and second portions is given by
$$( \frac{{w}_{i}}{\frac{n}{2}} ) ,$$
where wᵢ is the axial thickness of each segment, and n is the number of pieces in one helix turn.

29. The device according to claim 22, further comprising a translator disposed between the outer cylinder and inner rotor, the translator being substantially circular, centered along a transverse axial dimension of the outer cylinder, and wherein a portion of the at least one translator ring furthest from the axial translator axis is substantially perpendicular to the center of the at least one translator ring.
